(19) United States
(12) Patent Application Publication
(10) Pub. No.: US 2012/0120669 A1
(43) Pub. Date: May 17, 2012

(54) LIGHTING SYSTEM AND SWIVEL FIXTURE WITH LED ASSEMBLY

(76) Inventors: Thomas David McClellan, Santa Cruz, CA (US); Roy Johnson, Santa Cruz, CA (US)

(21) Appl. No.: 12/947,655

(22) Filed: Nov. 16, 2010

(51) Int. Cl. F21V 29/00; F28F 13/00; F21V 19/02

(52) U.S. Cl. 362/373; 362/418; 165/80.2

(57) ABSTRACT

A lighting fixture, including at least one swivel turret and a variable pressure clamp. Also a lighting system having a lighting fixture, which includes at least one swivel turret, and a variable pressure clamp, and also a lighting source which attaches to the lighting fixture. Also a tapered LED heat sink assembly having a heat sink housing which is configured as a finned concentric tube configuration with a tapered end and having a recess for receiving an LED module, and an LED module which is fitted into the recess.

Co-pending U.S. non-provisional pat application No. 12/902,041, entitled HEAT SINK AND LED COOLING SYSTEM is incorporated by reference in the present application.

### TECHNICAL FIELD

The present invention relates generally to illumination sources and more particularly to fixtures for directing LED illumination sources.

### BACKGROUND ART

Overhead lighting sources have been used for centuries in providing illumination for living spaces. It has long been known that it is advantageous to be able to direct the illumination beam of an overhead lighting source to light desired areas of a room or space. A lighting source that is mounted in one stationary position may be adequate for some applications, but it is generally desirable to have fixtures that are variable in direction, which are more flexible in application than stationary fixtures. A swivel fixture is one solution that may be practical for some applications, but it is important that the swivel be provided with enough stability that the direction of the lighting beam does not drift over time.

One example of an illumination source which has become increasingly used in recent years is the LED. A Light-Emitting Diode (LED) is a semiconductor light source, which have many practical applications due to their longer lifetime, faster switching, smaller physical size, greater durability and higher energy efficiency. LEDs have many advantages over other illumination sources. LEDs are solid state devices and if operated at low currents and at low temperatures, are subject to very limited wear and tear. Typical lifetimes are estimated to be 35,000 to 50,000 hours of useful life, compared to 10,000 to 15,000 hours for fluorescent tubes, and 1,000-2,000 hours for incandescent light bulbs. LEDs are also less fragile than fluorescent and incandescent bulbs, and are less suseptible to damage by external vibration.

LEDs produce more light per watt than incandescent bulbs, and are are ideal for use in applications that are subject to frequent on-off cycling, unlike fluorescent lamps that burn out more quickly when cycled frequently. LEDs can very easily be dimmed continuously unlike fluorescent lamps which require a certain threshold voltage to maintain illumination.

LEDs have been found to have significant environmental benefits compared to other alternatives. It has been estimated that a building's carbon footprint from lighting can be reduced by 68% by exchanging all incandescent bulbs for new LEDs. LEDs are also non-toxic compared to compact fluorescent, which contains traces of mercury. Organic light emitting diodes (OLEDs) can be produced that use an organic compound as the emitting layer material of the LED, which can be a polymer.

Performance of an LED is temperature dependent, and LED light output actually increases at cold temperatures. LEDs do not generate as much heat as incandescent bulbs, by not producing invisible light in the infrared range, but they do produce internal heat which must be disappated if the LED is to maintain good performance. Over-heating of the LED is a major factor in device failure. Heat sinks are necessary to maintain long life of the LED. This is especially important to have a low failure rate when LEDs are used in automotive, medical, and military applications where the device must operate over a large range of temperatures, and failure could create serious problems.

An improved LED assembly having a very efficient heat sink has been disclosed in U.S. patent application No. 12/902,041, which has been incorporated herein by reference. However, any heat sink will increase the weight of the LED and thus makes the stability of a directed light fixture harder to control.

There are of course many varieties of variable direction fixtures for lighting sources, such as the “goose neck lamp” but this style can be somewhat bulky and something more compact may be desirable. A swivel fixture may be practical for some applications, but it is imporatnt that the swivel be provided with enough stability that the direction of the lighting beam does not drift. This can especially become a problem when the illumination source has considerable weight. In this case, when this weight is aligned away from vertical, a rotational moment is created that tends to move the weighted lamp back towards vertical, thus causing drift in the beam direction.

Thus, there are competing criteria in designing a lighting fixture. The fixture should be flexible enough to allow for a range of motion, but stable enough that the light beam stays where it is directed without wandering or drifting.

These competing criteria are especially difficult to satisfy when a number of different lighting sources are used, each having it own weight and bulk considerations. It would be advantageous therefore to have a lighting system with a fixture in which the directional stability of the fixture was itself controllable.

Thus, there is need for a lighting fixture that has controllable directional stability, and especially a lighting fixture that operates with LED assemblies or other lighting sources, which may include considerable weight.

### DISCLOSURE OF INVENTION

Briefly, one preferred embodiment of the present invention is a lighting fixture, including at least one swivel turret and a variable pressure clamp.

Also disclosed is a lighting system having a lighting fixture, which includes at least one swivel turret, and a variable pressure clamp. The system also includes a lighting source which attaches to the lighting fixture.

Also disclosed is a tapered LED heat sink assembly having a heat sink housing which is configured as a finned concentric tube configuration with a tapered end and having a recess for receiving an LED module, and an LED module which is fitted into the recess.

An advantage of the present invention is that the fixture includes swivel turret attachments for multiple lighting sources, each of which can be directed independently within a range of angular directions.

Another advantage of the present invention is that it includes variable pressure clamps, which can stabilize the pointing directions of multiple lighting sources of differing weights.

Yet another advantage of the present invention is that it provides a tapered LED heat sink assembly configured as a finned concentric tube configuration, which fits well with the swivel turrets.

An additional advantage of the present invention is that the tapered LED heat sink assembly configured as a finned concentric tube configuration is lighter weight than previous finned concentric tube configuration LED heat sink assemblies, produces better cooling of LEDs and thus improves performance.

Another advantage of the present invention is it extends the working life of LEDs by providing better cooling.

A further advantage of the present invention is it makes LED lighting more dependable, and thus encourages their use for applications such as in medical devices, transportation devices, etc. where reliability is a very important factor.

And another advantage of the present invention is that by encouraging the use of more reliable LEDs, there are environmental benefits such as reducing carbon footprints of lighting devices.

Yet another advantage of the system of the present invention is it includes an air channel chimney in each of the swivel turrets, which also contributes to cooling.

An additional advantage of the present invention is that the tapered LED heat sink assemblies allow multiple focal optics to change the beam spread according to ceiling height. The heat sink device allows many different lens choices such as clear, frosted, linear, prismatic, etc, for all different applications such as commercial, industrial, retail etc.

These and other advantages of the present invention will become clear to those skilled in the art in view of the description of the best presently known modes of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows an isometric view of a lighting system of the present invention;

FIG. 2 shows a side cut-away view of a lighting fixture with swivel turret of the present invention;

FIG. 3 shows a side elevation view of a swivel turret with tapered LED heat sink assembly of the present invention;

FIG. 4 shows an exploded isometric view of a tapered LED heat sink assembly of the present invention;

FIG. 5 shows an isometric front view of the tapered heat sink housing of the present invention; and

FIG. 6 shows a rear elevation view of the heat sink housing of the present invention.

### DETAILED DESCRIPTION OF THE PREFERRED EMBODIMENTS

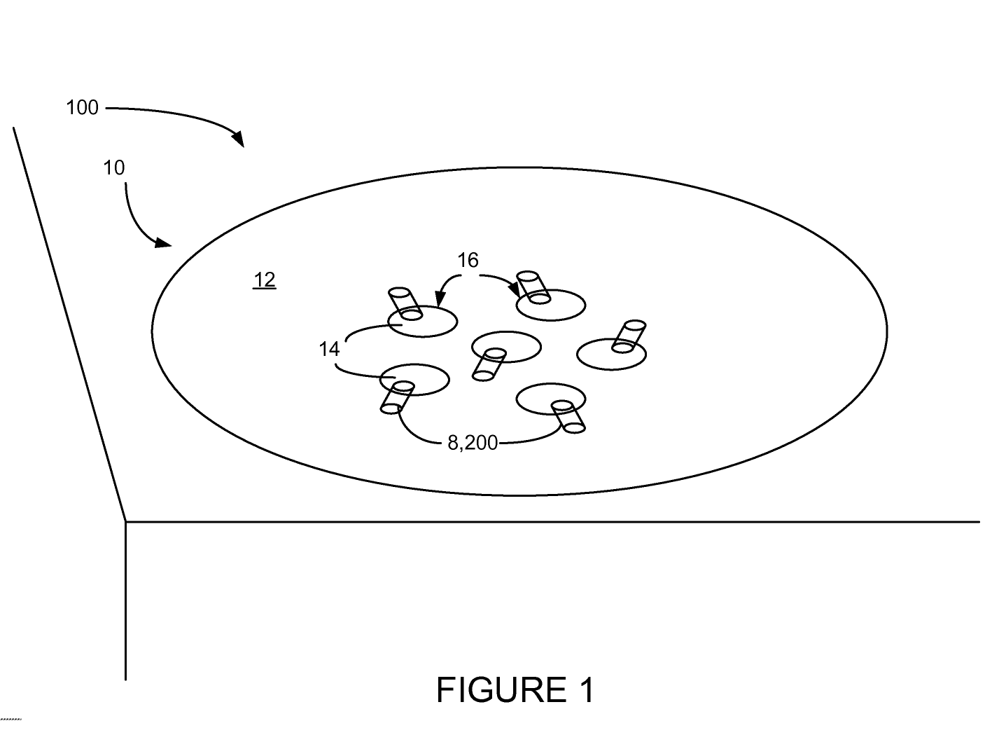

The present invention is a lighting system with a variable pressure swivel lighting fixture, which will be referred to by the reference number 100, and thus shall be referred to as lighting system 100. The variable pressure swivel lighting fixture will be referred to by the reference number 10 and thus shall be referred to as lighting fixture 10. Also disclosed is a tapered LED heat sink assembly 200. A preferred embodiment of the lighting system 100 with lighting fixture 10 and tapered LED heat sink assemblies 200 are illustrated in FIGS. 1-6.

FIG. 1 shows an isometric view of the lighting system 100 having lighting fixture 10 which is attached to a ceiling of a room. The fixture 10 generally includes a main body 12 and one or more swivel turrets 14 which attach to one or more light sources 8, preferably tapered LED heat sink assemblies 200, (discussed below) although they can also be almost any light bulb, incandescent or fluorescent. Within the main body 12, there are a number of openings 16 through which the swivel turrets 14 protrude. The swivel turrets 14 allow the lighting sources 8, 200 to be pointed in any direction within a range of angles of approximately 30 degrees from vertical, although this is not to be taken as a limitation.

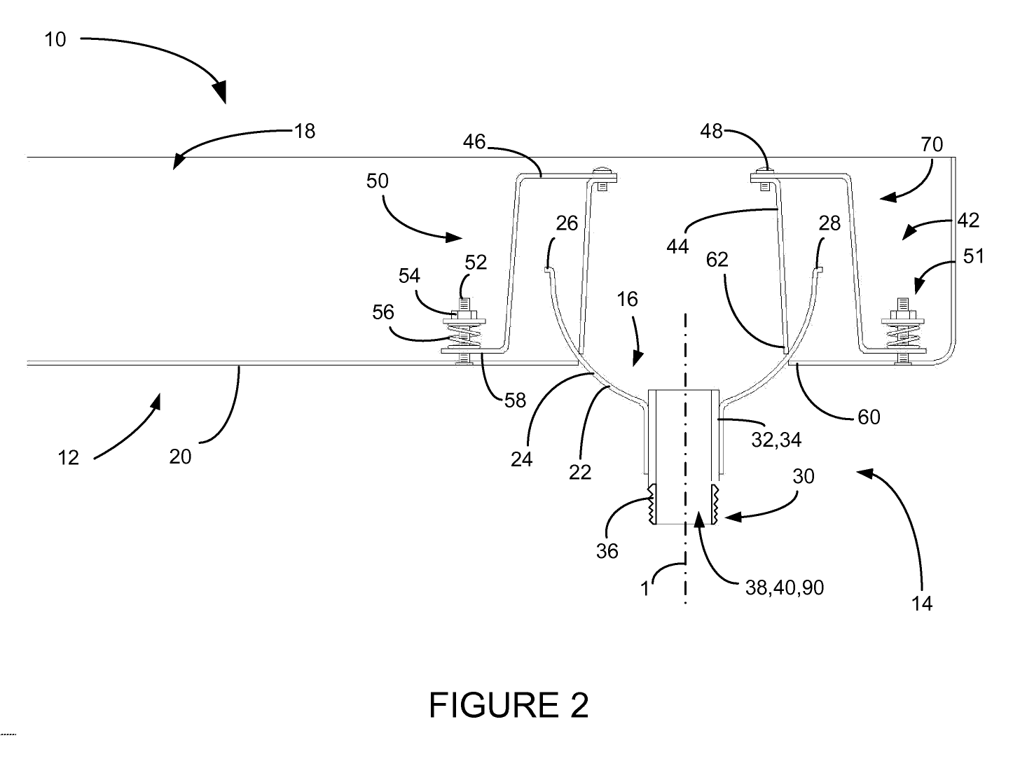

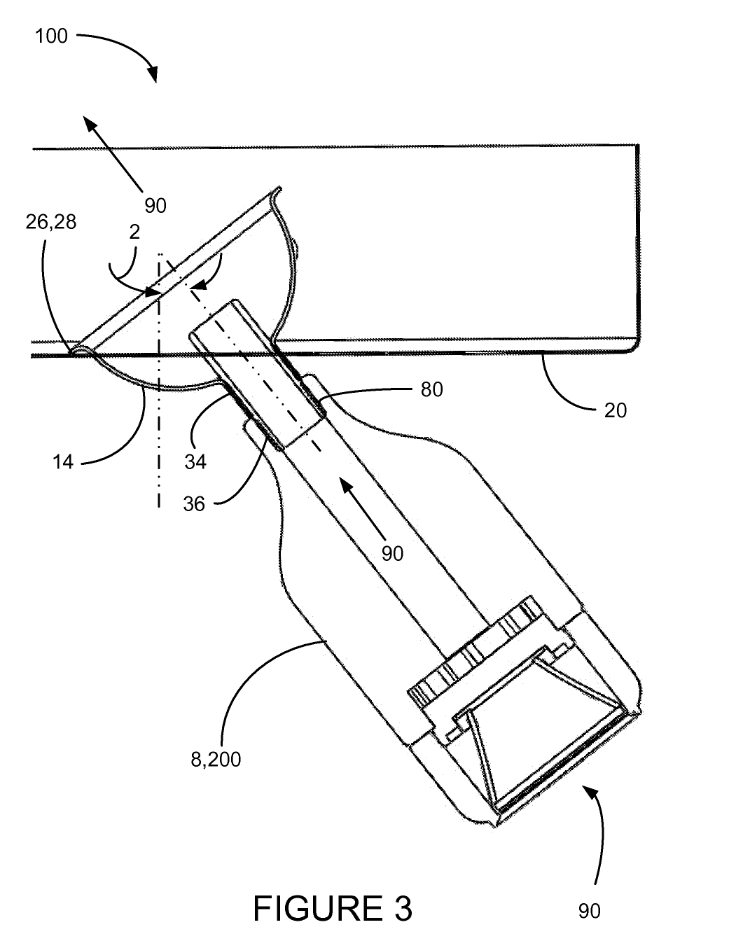

FIG. 2 shows a side cut-away view of a portion of the lighting fixture 10. The main body 12 of the lighting fixture 10 preferably has an open top surface 18 though which air can circulate to cool the LED heat sink assemblies 200 (see FIG. 3). There is a baseplate or bracket 20 through which the openings 16 are fashioned.

The swivel turret 14 is also shown in cut-away in this view. The swivel turret 14 includes a cup 22 having curved sides 24 which terminate in a ridge 26 at the upper edge 28. The lower end 30 of the cup 22 is formed into a tube 32 which includes a threaded socket 34 having male threads 36, and a central bore 38. The central bore 38 acts as a chimney 40, which channels heated air from the LED heat sink assembly (not shown) and allows cool air to circulate, as part of a cooling air passage 90, to be discussed below.

The swivel turret 14 is pressed against the interior of the main body 12 by a spring mechanism 42, which has a spun metal inner tube 44 and an outer cover 46, which are held together by a screw or fastener 48 to make a cover assembly 50. This cover assembly 50 is attached to the bracket 20 of the main body 12 by a captured spring assembly 51 which includes a bolt 52 and a nut 54, which have captured a spring 56 between the nut 54, (preferably with washer) and a flange 58 of the outer cover 46. The spring 56 urges the flange 58 and thus the outer cover 46 and cover assembly 50 downwards towards the bracket 20. The cup 22 portion of the swivel turret 14 is captured between the rim 60 of the bracket 20, which surrounds the opening 16, and the edge 62 of the inner tube 44, in a manner which still allows the turret 14 to rotate and swivel within the confines of the fixture 10, but subject to an opposing force controlled by the pressure exerted by the spring mechanism 42, which tends to stabilize its position.

The angular travel of the cup 22 is limited by the ridge 26, which is formed at the upper edge 28 of the cup 22. It is apparent that when the ridge 26 contacts the rim 60 of the bracket 20 and edge 62 of the inner tube 44, further travel is stopped, and the cup 22 is not allowed to swivel out of the opening 16.

The nuts 54 can be tightened to increase the compression of the spring 56, and thus the pressure exerted on the cover assembly 50, and on the cup 22. This provides a variable pressure clamp 70 on the swivel turret 14, and is an important and novel feature of the present invention, as will be discussed further below.

The fixture 10 is designed to accept a variety of lighting devices, including the LED heat sink assemblies disclosed in co-pending U.S. patent application No. 12/902,041. FIG. 3 shows a side elevation view of a swivel turret 14 with an LED heat sink assembly 200 mounted on it. The LED heat sink assembly 200 preferably includes a female threaded portion 80 which mates with the external male threads 36 of the threaded socket 34 of the swivel turret 14.

It can be seen that the angular tilt of the swivel turret 14 is limited by the ridge 26 on the upper edge 28 of the cup 22 as it contacts the bracket 20. The design shown here has an angle range 2 of approximately 30 degrees, although this can be subject of variation, and is not to be construed as a limitation.

The LED heat sink assemblies 200 are very energy efficient and have many advantages over other forms of lighting. The LED heat sink assemblies 200 do have a certain amount of weight, which is easily supported when they hang vertically, and their center of gravity roughly aligns with a central axis 1 of the central bore of the swivel turret 14, as seen in FIG. 1. When they are angled to direct the light beams in various direction, their center of gravity shifts to a vertical line displaced from the central axis, and thus creates a rotational moment that urges the LED heat sink assembly 100 to rotate until they hang vertically. If the lighting source is to remain pointing in a stable manner, this rotational moment must be opposed, in this case by clamping pressure from the variable pressure clamp 70. Thus, it is important that the swivel turret 14 have enough pressure applied to it that this rotational moment is opposed, and the LED remain pointing as desired.

Since many lighting sources of differing weights are to be accommodated by the fixture 10, it is an advantage that the pressure on the swivel turret cup 22 be adjustable to suit the user's needs. If light-weight lamps are to be used, then the pressure may be relieved by loosening the nuts 54, and relaxing the pressure of the springs 56. This would allow the swivel turrets to swivel more freely, and may be easier for a user to direct. When lamps or LED heat sink assemblies of greater weight are to be used, the nuts 54 can be tightened and the turrets 14 become more directionally stable and harder to rotate, and the directionality of beams is more securely fixed.

Although the straight LED heat sink assemblies disclosed in co-pending. U.S. patent application No. 12/902,04, are suitable for use with the present fixture 10, a specially designed LED heat sink assembly with a tapered end is preferred. It fits smoothly into the fixture's sockets, and its rear end is of smaller diameter, thus edges of rear portion will not contact the fixture as the swivel turret is angled, and thus will not interfere with the positioning of the light beam produced.

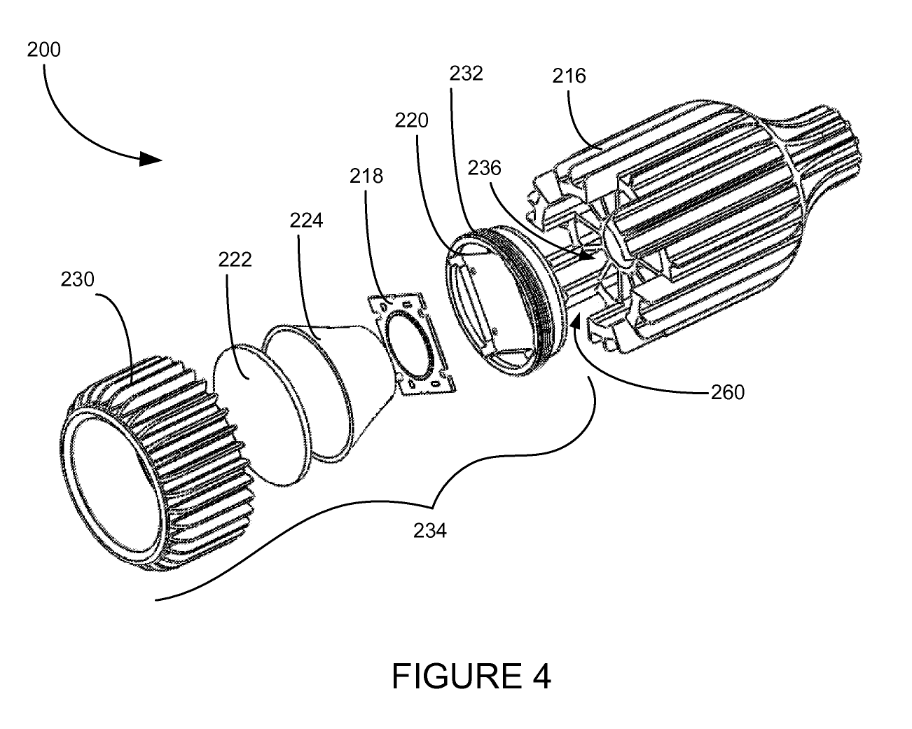

This tapered LED heat sink assembly 200 is shown in FIGS. 3-6. The tapered LED heat sink assembly 200 has the basic elements shown in the exploded isometric view of FIG. 4. The LED module 234 fits into the tapered heat sink housing 216 to form the tapered LED heat sink assembly 200. The LED module 234 includes an LED 218, an LED housing 220, a lens 222, a reflector 224 and a cap 230, which attaches to the LED housing 220 by screw threads 232.

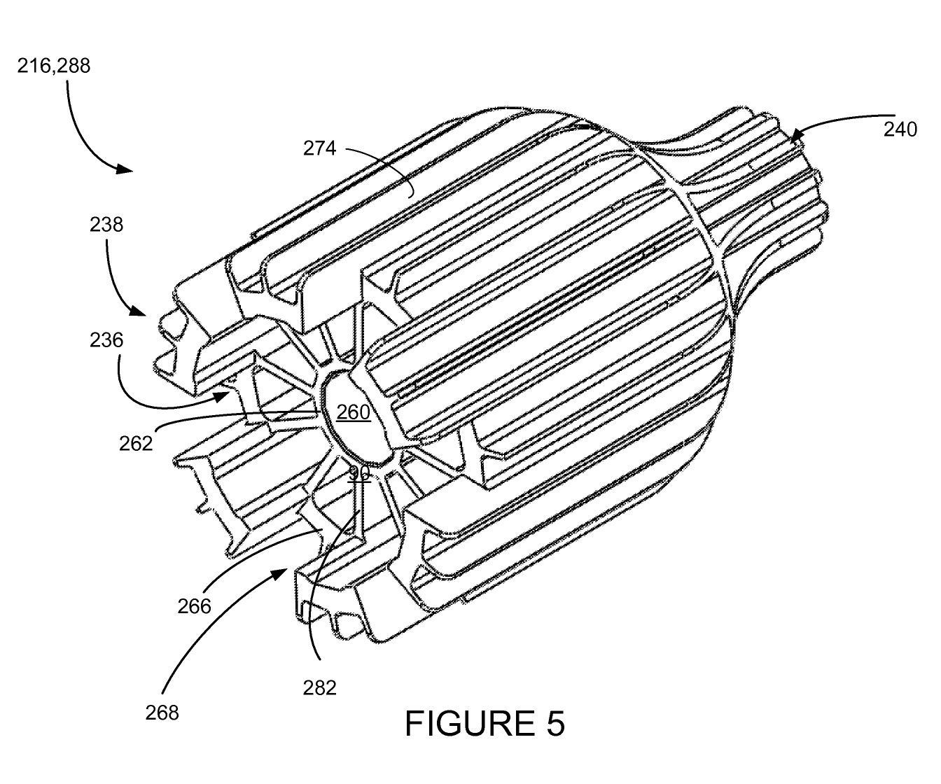

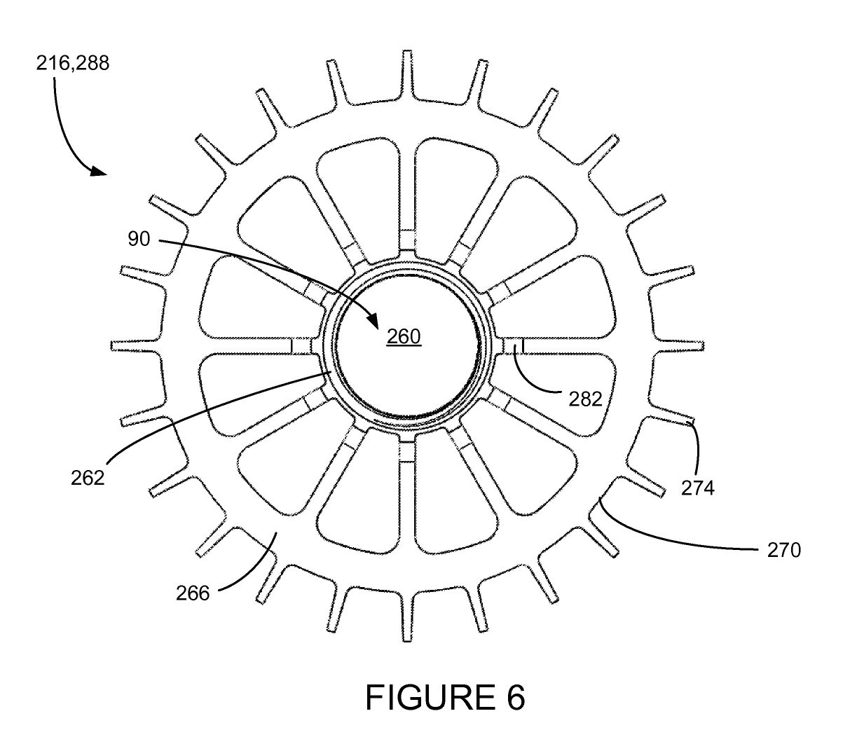

As shown in especially in FIGS. 5 and 6, the LED housing 216 includes a tapered rear portion 240, which is tapered to present a smooth profile that blends into the lines of the swivel turrets 14 of the fixture 10, and provides free movement of the swivel turret 14. The front portion 238 includes a recess 236 which is configured to receive the LED module 234.

The tapered heat sink housing 216 is of a finned concentric tube 288 configuration. This includes an inner tube 262 surrounding a central bore 260 and an outer tube 266, and has internal fins 282 connecting the two tubes 262, 266. External fins 274 are also preferably included, and these elements have been carefully analyzed and designed with regard to multiple parameters, such as thickness, height and spacing, to give very efficient air flow and heat transfer away from the LED module 234. These parameters are discussed at length in co-pending U.S. patent application No. 12/902,041.

Applicant has found that this finned concentric tube configuration 288 to be especially effective at providing excellent heat transfer from the LED module 234. When used with the swivel turrets 14 of the lighting system 100, the central bore 260 of the LED heat sink housing 216 roughly aligns with the chimney 40 of the tube 32 of the swivel turret 14, thus providing a cooling air channel 90 which extends from the LED housing 220, through the LED heat sink housing 216, through the chimney 40 and out into the open top surface 18 of the fixture 10 to provide excellent air circulation. This air circulation is also aided by air entering the side vents 268 of the heat sink housing 216 and from a cooling cavity formed between the back of the LED housing 220 and the body of the heat sink housing 216, as discussed in co-pending U.S. patent application No. 12/902,041.

While various embodiments have been described above, many alternatives, modifications and variations will be apparent to those skilled in the art, and it should be understood that they have been presented by way of example only, and not limitation. Various changes may be made without departing from the spirit and scope of this invention.

### INDUSTRIAL APPLICABILITY

The present the lighting system 100 with lighting fixture 10 and tapered LED heat sink assemblies 200 is well suited generally for lighting applications, both indoor and outdoor.

It is well known that it is advantageous to be able to direct the illumination beam of an illumination source to illuminate desired areas of a room or space. An illumination source that is mounted in one stationary position may be adequate for some applications, but it is generally desirable to have fixtures that are variable in direction, which are more flexible in application than stationary fixtures. A swivel fixture may be practical for some applications, but it is imporatnt that the swivel be provided with enough stability that the direction of the lighting beam does not drift. This can especially become a problem when the illumination source has considerable weight.

The fixture should be flexible enough to allow for a range of motion, but stable enough that the light beam stays where it is directed without wandering or drifting. These competing criteria are especially difficult to satisfy when a number of different lighting sources are used, each having it own weight and bulk considerations. It would be advantageous therefore to have a lighting system with a fixture in which the directional stability of the fixture was itself controllable.

LEDs are solid state devices which are becoming used in more and more applications due to their greater energy efficiency and low operating costs. If operated at low currents and at low temperatures, LEDS are subject to very limited wear and tear. Typical lifetimes are estimated to be 35,000 to 50,000 hours of useful life, compared to 10,000 to 15,000 hours for fluorescent tubes, and 1,000-2,000 hours for incandescent light bulbs. LEDs are also less fragile than fluorescent and incandescent bulbs, and are less suseptible to damage by external shock. LEDs produce more light per watt than incandescent bulbs, and have been found to have significant environmental benefits compared to other alternatives. It has been estimated that a building's carbon footprint from lighting can be reduced by 68% by exchanging all incandescent bulbs for new LEDs.

However, efficiencies and lifetimes of LEDs are dependent on adequate cooling. Thus it is very imp;ortant that low temperatures are maintained, and for this reason an improvement in heatsinks for LEDs is a very important development. However, heat sinks can increase the weight of an LED assembly, and if mounted in a fixture with inadequate stability can drift in position.

The present lighting system 100 addresses these concerns by providing a lighting fixture 10 with a variable pressure clamping mechanism 70. The fixture 10 generally includes a main body 12 and one or more swivel turrets 14 which attach to one or more light sources 8, preferably LED heat sink assemblies 200, although they can also be almost any light bulb, incandescent or fluorescent. Within the main body 12, there are a number of openings 16 through which the swivel turrets 14 protrude. The swivel turrets 14 allow the lighting sources 8, 200 to be pointed in any direction within an angle of approximately 30 degrees from vertical, although this is not to be taken as a limitation.

The swivel turret 14 includes a cup 22 having curved sides 24 which terminate in a ridge 26 at the upper edge 28. The lower end 30 of the cup 22 is formed into a tube 32 which includes a threaded socket 34 having internal female threads 36, and a central bore 38. The central bore 38 acts as a chimney 40, which channels heated air from the LED heat sink assembly and allows cool air to circulate.

The swivel turret 14 is held by a spring mechanism 42, which has a spun metal inner tube 44 and an outer cover 46, which are held together by a screw or fastener 48 to make a cover assembly 50. This cover assembly 50 is attached to the bracket 20 of the main body 12 by a captured spring assembly 51, including a bolt 52 and a nut 54, which have captured a spring 56 between the nut 54 and a flange 58 of the outer cover 46. The spring 56 urges the flange 58 and thus the outer cover 46 and cover assembly 50 downwards towards the bracket 20. The cup 22 portion of the swivel turret 14 is captured between the rim 60 of the bracket 20, which surrounds the opening 16, and the edge 62 of the inner tube 44, in a manner which still allows the turret 14 to rotate and swivel within the confines of the fixture 10. The travel of the cup 22 is limited by the ridge 26, which is formed at the upper edge 28 of the cup 22.

The nuts 54 can be tightened to thus increase the compression of the spring 56, and thus increase the pressure exerted on the cover assembly 50, and on the cup 22. This provides for a variable pressure clamp 70 on the swivel turret 14.

As discussed above, the preferred illumination source for use with the fixture 10 is an LED heat sink assembly. For use with this fixture 10, a specially designed LED heat sink assembly with a tapered end is preferred. It fits smoothly into the fixture's sockets, and its rear end is of smaller diameter than the front end, thus edges of rear portion will not contact the fixture as the swivel turret is angled. This allows a greater range of directions for the light beam produced.

This tapered LED heat sink assembly 200 has an LED module 234 that fits into the tapered heat sink housing 216 to form the tapered LED heat sink assembly 200. The LED module 234 includes an LED 218, an LED housing 220, a lens 222, a reflector 224 and a cap 230, which attaches to the LED housing 220 by screw threads 232.

The tapered rear portion 240 is shaped to present a smooth profile that blends into the swivel turrets 14 of the fixture 10, and provides free movement of the swivel turret. The front portion 238 includes a recess 236 which is configured to receive the LED module 234.

The tapered heat sink housing 216 is configured as a finned concentric tube configuration 288. This includes an inner tube 262 and an outer tube 266 which have internal fins 282 connecting the two tubes 262, 266. External fins 274 are also preferably included, and these elements have been carefully analyzed and designed with regard to multiple parameters to give very efficient air flow and heat transfer away from the LED module 234.

Applicant has found this finned concentric tube configuration 288 to be especially effective at providing excellent heat transfer from the LED module 234. When attached to one of the swivel turrets 14, the central bore 260 of the LED heat sink 216 roughly aligns with the chimney 40 of the tube 32 of the swivel turret 14 thus providing a cooling air channel 90 which extends from the LED housing 220, through the LED heat sink housing 216, through the chimney 40 and out into the open top surface 18 of the fixture 10 to provide excellent air circulation. This air circulation is also aided by air entering the side vents 268 of the heat sink housing 216 and from a cooling cavity formed between the back of the LED housing 220 and the body of the heat sink housing 216.

Many variations of in the lighting system 100, and the lighting fixture 10 are possible, and are very adaptable to a variety of applications. The lighting fixture 10 can have almost any number of swivel turrets 14 that can physically fit into the main body 12. Each swivel turret 14 can be individually angled to provide beams wherever desired in a space. Each turret 14 will fit multiple LED types, and can used with single or multiple LEDs 218. The LED module 234 can hold a variety of different lenses i.e.: clear, prismatic, frosted, linear, etc. It is possible to use an extended cover with varying focal properties to change light beam spreads. An additional focal optic can be added to allow the different focal beam spreads. This will allow the lighting system 100 to be place at a higher level in the building or outside application such as parking and street lighting. Different lens options can be added to enhance the light output or change the direction of the light output such as diffusion or linear spread of light in a line. Different color temperature LEDs can change the color output of the light. Color changing LED's with red, green, blue and white LED's can be used. The LEDs 218 in the system 100 can be dimmed in an almost continuous manner, in digital steps of 0 to 255 levels or more if needed, unlike fluorescent lights, which require certain threshold voltages to remain illuminated.

The fixture 10 can be configured as a canopy, or as a linear track. The LED heat sink assemblies 200 can be different sizes, and they can be fabricated in any color, and can be made of different materials such as aluminum, copper, brass, etc. The LED module 234 itself can have different shapes and sizes of shapes, and the present tapered heat sinks housings 216 can be configured to receive them.

In short, almost anywhere that standard lighting is used, the present lighting system with variable pressure clamps and tapered LED heat sink assemblies can be used. The savings in energy use and the reduction in the carbon footprint created can have huge environmental and social benefits.

For the above, and other, reasons, it is expected that the lighting system 100 with lighting fixture 10 and tapered led heat sink assemblies 200 of the present invention will have widespread industrial applicability. Therefore, it is expected that the commercial utility of the present invention will be extensive and long lasting.

What is claimed is:

1. A lighting fixture, comprising:
at least one swivel turret; and
a variable pressure clamp.

2. The lighting fixture of claim 1, wherein said swivel turret comprises:
a cup having curved sides; and
a tube attached to said cup, said tube being configured to attach lighting sources.

3. The lighting fixture of claim 2, wherein said variable pressure clamp comprises:
a spring mechanism which exerts variable pressure on said curved sides of said cup to maintain it in a stable position under varying weight loads.

4. The lighting fixture of claim 3, wherein said spring mechanism comprises:
a cover assembly; and
a captured spring assembly which exerts variable pressure.

5. The lighting fixture of claim 4, wherein said cover assembly comprises:
an outer cover having a flange;
an inner tube; and
a fastener which attaches said outer cover to said inner tube.

6. The lighting fixture of claim 5, further comprising:
a main body having a bracket.

7. The lighting fixture of claim 6, wherein said captured spring assembly comprises:
a bolt;
a nut;
a spring captured between said nut and said flange of said outer cover, and said cup is captured between said main body and said cover assembly so that pressure from said spring urges said swivel turret to remain stationary.

8. The lighting fixture of claim 1, wherein said fixture comprises multiple turrets.

9. The lighting fixture of claim 8, wherein each of said multiple turrets can be directed independently.

10. The lighting fixture of claim 9, wherein each of said multiple turrets can be directed independently in a range of 30 degrees from vertical.

11. The lighting fixture of claim 9, wherein the range of motion of each of said multiple turrets is limited by a ridge on said cup of said turret.

12. The lighting fixture of claim 2, wherein said tube is configured as an air flow chimney.

13. A lighting system comprising:
a lighting fixture, including at least one swivel turret and a variable pressure clamp; and
a lighting source which attaches to said lighting fixture.

14. The lighting system of claim 13, wherein:
said lighting source is an LED heat sink assembly.

15. The lighting system of claim 14, wherein:
said lighting source is a tapered LED heat sink assembly having a tapered heat sink housing which is configured as a finned concentric tube configuration and having a recess for receiving an LED module; and
an LED module which is fitted into said recess.

16. The lighting system of claim 15, wherein:
said tapered heat sink housing has a central bore, and said swivel turret has a tube with a central bore that acts as a chimney, where the two central bores are aligned to provide a cooling air channel that provides cooling air to said LED module.

17. The lighting system of claim 13, wherein said swivel turret comprises:
a cup having curved sides and a tube configured to attach lighting sources; and
said variable pressure clamp comprises a spring mechanism which exerts variable pressure on said curved sides of said cup to maintain it in a stable position under varying weight loads.

18. A tapered LED heat sink assembly comprising:
a heat sink housing which is configured as a finned concentric tube configuration with a tapered end and having a recess for receiving an LED module; and
an LED module which is fitted into said recess.

19. The tapered LED heat sink assembly of claim 18, wherein said heat sink housing includes external fins.

20. The tapered LED heat sink assembly of claim 18, wherein said finned concentric tube configuration includes an inner tube and an outer tube which are connected by internal fins.
